(19) United States
(12) Patent Application Publication
(10) Pub. No.: US 2024/0027828 A1
(43) Pub. Date: Jan. 25, 2024

(54) DISPLAY APPARATUS

(71) Applicant: SAMSUNG ELECTRONICS CO., LTD., Suwon-si (KR)

(72) Inventors: Daesik KIM, Suwon-si (KR); Kyonghyong KIM, Suwon-si (KR); Jongil KIM, Suwon-si (KR); Yasuhiro NISHIDA, Suwon-si (KR)

(73) Assignee: SAMSUNG ELECTRONICS CO., LTD., Suwon-si (KR)

(21) Appl. No.: 18/199,654

(22) Filed: May 19, 2023

Related U.S. Application Data
(63) Continuation of application No. PCT/KR23/05017, filed on Apr. 13, 2023.

(30) Foreign Application Priority Data
Jul. 19, 2022 (KR) 10-2022-0089209

(51) Int. Cl. G02F 1/13357; G02F 1/1335

(52) U.S. Cl. CPC G02F 1/133603; G02F 1/133605; G02F 1/133607

(57) ABSTRACT

The present disclosure provides display apparatuses including a backlight unit (BLU). In some embodiments, the display apparatus includes a liquid crystal panel, and a BLU configured to provide light to the liquid crystal panel. The BLU includes a substrate, a plurality of light-emitting diodes (LEDs) on the substrate and configured to emit the light, a plurality of refractive covers, and a plurality of reflectors on the substrate disposed between the plurality of LEDs and configured to reflect the light emitted from the plurality of LEDs. Each refractive cover is disposed on a corresponding LED of the plurality of LEDs.

### CROSS-REFERENCE TO RELATED APPLICATIONS

This application is a continuation application of International Application No. PCT/KR2023/005017, filed on Apr. 13, 2023, which claims priority to Korean Patent Application No. 10-2022-0089209, filed on Jul. 19, 2022, in the Korean Intellectual Property Office, the disclosures of which are incorporated by reference herein in their entireties.

### BACKGROUND

### 1. Field

The present disclosure relates generally to a display apparatus, and more particularly, to a display apparatus including a backlight unit.

### 2. Description of Related Art

A display apparatus may refer to a type of output device that may convert acquired and/or stored electrical information into visual information and that may display the converted information to a user.

A display apparatus may include a liquid crystal panel and a backlight unit (BLU) providing light to the liquid crystal panel. The BLU may include a plurality of point light sources capable of independently emitting light.

Recently, display apparatuses may have become thinner. One potential method of reducing the thickness of the display apparatuses may be to reduce an optical distance (OD) of the display apparatuses.

### SUMMARY

The present disclosure provides a display apparatus with reduced thickness by reducing the optical distance (OD).

The present disclosure provides a display apparatus with potentially improved luminance uniformity by reducing a dark area of a backlight unit.

The present disclosure provides a display apparatus including an array of reflectors disposed between light sources of a backlight unit (BLU) to reflect light while supporting a diffuser plate and/or a composite sheet.

According to an aspect of the present disclosure, a display apparatus is provided. The display apparatus includes a liquid crystal panel, and a backlight unit (BLU) configured to provide light to the liquid crystal panel. The BLU includes a substrate, a plurality of light-emitting diodes (LEDs) on the substrate and configured to emit the light, a plurality of refractive covers, and a plurality of reflectors on the substrate disposed between the plurality of LEDs and configured to reflect the light emitted from the plurality of LEDs. Each refractive cover is disposed on a corresponding LED of the plurality of LEDs.

In some embodiments, the plurality of LEDs may be spaced apart from each other at a first interval along a first direction on the substrate. The plurality of LEDs may be spaced apart from each other at the first interval along a second direction on the substrate. The second direction may be perpendicular to the first direction.

In some embodiments, the plurality of reflectors may be spaced apart from each other at a second interval along a third direction on the substrate. The second interval may be greater than the first interval. The third direction may be diagonal to the first direction and to the second direction.

In some embodiments, each of the plurality of reflectors may be provided in a shape of a frustum of a square pyramid. Each side surface of the shape of the frustum of the square pyramid may face a corresponding adjacent LED of the plurality of LEDs.

In some embodiments, the plurality of reflectors may be provided in a shape of at least one of a frustum of a cone, a frustum of a polygonal pyramid, a cone, and a polygonal pyramid.

In some embodiments, the plurality of reflectors may include a plurality of protrusions that may protrude from the substrate toward the liquid crystal panel, and a plurality of protrusion covers that may be respectively disposed on the at least one side surface of the plurality of protrusions to form at least one reflective surface on each protrusion of the plurality of protrusions. Each protrusion of the plurality of protrusions may have at least one side surface.

In some embodiments, the BLU may further include a reflector sheet disposed on the substrate. The reflector sheet may include the plurality of protrusion covers, a plurality of through holes corresponding respectively to the plurality of LEDs, and a plurality of cutouts formed by a portion of the reflector sheet incised such that at least one region of the reflector sheet forms the plurality of protrusion covers. Each of the plurality of LEDs may pass through the corresponding through hole of the plurality of through holes.

In some embodiments, the at least one region of the reflector sheet may be coated with phosphor and may be configured to convert a wavelength of light incident on the at least one reflective surface.

In some embodiments, the BLU may further include a composite sheet disposed between the substrate and the liquid crystal panel, and an adhesive layer that may be provided on a surface of the composite sheet and disposed between the composite sheet and the substrate, and configured to bond the composite sheet to the plurality of reflectors.

In some embodiments, the composite sheet includes a reflector sheet configured to selectively reflect incident light, a diffuser sheet configured to diffuse the incident light, a light conversion sheet configured to convert a wavelength of the incident light, and a prism sheet comprising a prism pattern.

In some embodiments, the plurality of reflectors support the composite sheet such that an air gap may be formed between the composite sheet and the substrate.

In some embodiments, the BLU may further include a diffuser plate disposed between the substrate and the liquid crystal panel and configured to diffuse incident light, an optical sheet provided on a first surface of the diffuser plate and disposed between the diffuser plate and the liquid crystal panel, and an adhesive layer provided on a second surface of the diffuser plate and configured to bond the diffuser plate to the plurality of reflectors. The optical sheet may include at least one of a light conversion sheet, a prism sheet, and a reflective polarizing sheet

In some embodiments, the plurality of LEDs may be mounted on the substrate in a chip on board (COB) method.

In some embodiments, the plurality of refractive covers may have been formed by a transparent material in a liquid state that may have been dispensed at a plurality of points and cured. The transparent material in the liquid state may have a refractive index higher than a refractive index of air.

According to an aspect of the present disclosure, a display apparatus is provided. The display apparatus includes a liquid crystal panel, and a BLU configured to provide light to the liquid crystal panel. The BLU includes a substrate, a plurality of LEDs on the substrate and configured to emit the light, a plurality of refractive covers, and a plurality of reflectors on the substrate disposed between the plurality of LEDs and configured to reflect the light emitted from the plurality of LEDs. The plurality of LEDs are spaced apart from each other at a first interval along a first direction on the substrate. The plurality of LEDs are spaced apart from each other at the first interval along a second direction on the substrate. The second direction is perpendicular to the first direction. Each refractive cover is disposed on a corresponding LED of the plurality of LEDs. The plurality of reflectors are spaced apart from each other at a second interval along a third direction on the substrate. The second interval is greater than the first interval. The third direction is diagonal to the first direction and to the second direction.

In some embodiments, each of the plurality of reflectors may be provided in a shape of a frustum of a square pyramid. Each side surface of the shape of the frustum of the square pyramid may face a corresponding adjacent LED of the plurality of LEDs.

In some embodiments, the plurality of reflectors may include a plurality of protrusions that may protrude from the substrate toward the liquid crystal panel, and a plurality of protrusion covers that may be respectively disposed on the at least one side surface of the plurality of protrusions to form at least one reflective surface on each protrusion of the plurality of protrusions. Each protrusion of the plurality of protrusions may have at least one side surface

In some embodiments, the BLU may include a composite sheet disposed between the substrate and the liquid crystal panel, and an adhesive layer provided on a surface of the composite sheet and disposed between the composite sheet and the substrate, and configured to bond the composite sheet to the plurality of reflectors.

In some embodiments, the plurality of reflectors may support the composite sheet such that an air gap may be formed between the composite sheet and the substrate.

In some embodiments, the BLU may further include a diffuser plate disposed between the substrate and the liquid crystal panel and configured to diffuse incident light, an optical sheet provided on a first surface of the diffuser plate and disposed between the diffuser plate and the liquid crystal panel, the optical sheet comprising at least one of a light conversion sheet, a prism sheet, and a reflective polarizing sheet, and an adhesive layer provided on a second surface of the diffuser plate and configured to bond the diffuser plate to the plurality of reflectors.

According to an aspect of the present disclosure, a display apparatus with reduced thickness is provided by reducing the optical distance (OD).

According to an aspect of the present disclosure, a display apparatus with improved luminance uniformity is provided by reducing a dark area of a backlight unit (BLU).

According to an aspect of the present disclosure, a display apparatus including an array of reflectors disposed between light sources of a BLU to reflect light while supporting a diffuser plate or a composite sheet is provided.

Additional aspects may be set forth in part in the description which follows and, in part, may be apparent from the description, or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a view illustrating an example of an external appearance of a display apparatus, according to an embodiment;

FIG. 2 is a view illustrating an example of a structure of a display apparatus, according to an embodiment;

FIG. 3 is a view illustrating an example of a liquid crystal panel, according to an embodiment;

FIG. 4 is an exploded view illustrating a backlight unit (BLU), according to an embodiment;

FIG. 5 is a schematic view illustrating an example of a light source included in a BLU, according to an embodiment;

FIG. 6 is a view illustrating an example of a light emitting diode (LED) included in a BLU, according to an embodiment;

FIG. 7 is a view illustrating the intensity of light emitted from the LED of FIG. 6 according to emission angles, according to an embodiment;

FIG. 8 is an enlarged view of part A of FIG. 4, according to an embodiment;

FIG. 9 is an enlarged view of part B of FIG. 4, according to an embodiment;

FIG. 10 is a view illustrating a state in which a reflector sheet is disposed on a light source module in a BLU, according to an embodiment;

FIG. 11 is a cross sectional view of a liquid crystal panel and a BLU taken along line C-C′ of FIG. 10, in a display apparatus, according to an embodiment;

FIG. 12 is a view illustrating a light source module and a reflector sheet in a BLU, according to an embodiment;

FIG. 13 is an enlarged view of part D of FIG. 12, according to an embodiment;

FIG. 14 is an exploded view of a BLU, according to an embodiment;

FIG. 15 is a cross-sectional view of a liquid crystal panel and a BLU, according to an embodiment;

FIG. 16 is a view illustrating a protrusion of a reflector in a BLU, according to an embodiment;

FIG. 17 is a view illustrating a protrusion of a reflector in a BLU, according to an embodiment;

FIG. 18 is a view illustrating a protrusion of a reflector in a BLU, according to an embodiment; and

FIG. 19 is a view illustrating a reflector in a BLU, according to an embodiment.

### DETAILED DESCRIPTION

Embodiments described in the specification and configurations shown in the accompanying drawings are merely examples of the present disclosure, and various modifications may replace the embodiments and the drawings of the present disclosure at the time of filing of the application.

Further, identical symbols or numbers in the drawings of the present disclosure denote components or elements configured to perform substantially identical functions.

Further, terms used herein are only for the purpose of describing particular embodiments and are not intended to limit to the present disclosure. The singular form is intended to include the plural form as well, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Further, it should be understood that, although the terms “first,” “second,” and the like may be used herein to describe various elements, the elements are not restricted by the terms, and the terms are only used to distinguish one element from another. For example, a first element could be termed a second element, and similarly, a second element could be termed a first element without departing from the scope of the present disclosure. The term “and/or” includes combinations of one or all of a plurality of associated listed items. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

The terms “front”, “rear”, “left”, “right”, and the like as herein used are defined with respect to the drawings, but the terms may not restrict the shape and position of the respective components. It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, and the like may be replaced with terms, such as “first,” “second,” third” to be used to describe relative positions of elements. The terms “first,” “second,” third” may be used to described various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout the present disclosure may, but do not necessarily, all refer to the same embodiment.

As used herein, each of the terms “Al₂O₃”, “GaN”, and the like may refer to a material made of elements included in each of the terms and is not a chemical formula representing a stoichiometric relationship.

Hereinafter, embodiments according to the present disclosure are described in detail with reference to the accompanying drawings.

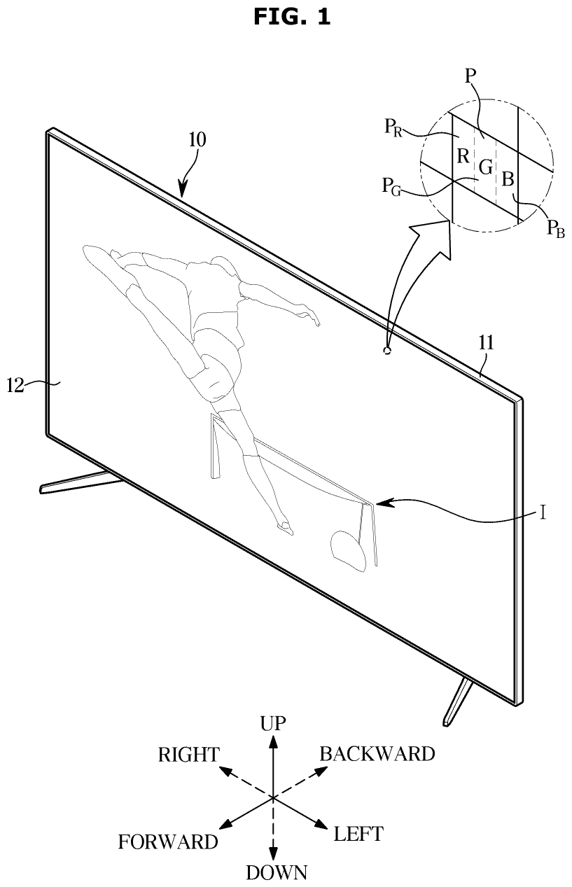

FIG. 1 is a view illustrating an example of an external appearance of a display apparatus, according to an embodiment.

Referring to FIG. 1, a display apparatus 10 may include a device capable of processing an image signal received from the outside and visually displaying a processed image. Hereinafter, a case in which the display apparatus 10 includes a television (TV) may be exemplified. However, the present disclosure may not be limited in this regard. For example, the display apparatus 10 may be implemented in various forms, such as, but not limited to, a monitor, a portable multimedia device, a portable communication device, and the like. That is, the aspects presented herein may be employed with any form of the display apparatus 10 that visually displays an image.

In an embodiment, the display apparatus 10 may include a large format display (LFD) installed outdoors, such as, but not limited to, on a roof of a building or at a bus stop. Alternatively or additionally, the location of the display apparatus 10 may not be necessarily limited to the outdoors. For example, the display apparatus 10 may be installed wherever a large number of people may enter and exit, including indoor locations, such as, but not limited to, subway stations, shopping malls, movie theaters, companies, stores, and the like.

In an embodiment, the display apparatus 10 may receive content data including a video signal and/or an audio signal from various content sources. The display apparatus 10 may output video (e.g., images) and/or audio (e.g., sound) corresponding to the video signal and/or audio signal. For example, the display apparatus 10 may receive content data through a broadcast reception antenna and/or a wired cable, receive content data from a content playback apparatus, and/or receive content data from a content-providing server of a content provider. That is, the present disclosure may not be limited in this regard. For example, the display apparatus 10 may obtain video and/or audio signals via interfaces other than the interfaces described above without departing from the scope of the present disclosure. Alternatively or additionally, the display apparatus may access video and/or audio signals stored therein.

As shown in FIG. 1, the display apparatus 10 may include a body 11 and a screen 12 displaying an image I.

The body 11 may form the exterior of the display apparatus 10. For example, inside the body 11 there may be provided one or more components (not shown) configured to allow the display apparatus 10 to display the image I and/or perform various functions. Although the body 11 shown in FIG. 1 may be illustrated as having a flat plate shape, the shape of the body 11 may not be limited to that shown in FIG. 1. For example, the body 11 may have a curved plate shape.

The screen 12 may be formed on a front surface of the body 11 and may display the image I. For example, the screen 12 may display a still image and/or a video. Alternatively or additionally, the screen 12 may display a two-dimensional (2D) planar image and/or a three-dimensional (3D) stereoscopic image using a binocular parallax of a user.

In an embodiment, the screen 12 may include a non-self-luminous panel (e.g., a liquid crystal panel) that may transmit and/or block light emitted by a backlight unit (BLU) or the like.

A plurality of pixels P may be formed on the screen 12. In an embodiment, the image I displayed on the screen 12 may be formed by light emitted from each of the plurality of pixels P. For example, the image I may be formed on the screen 12 by combining light emitted from the plurality of pixels P like a mosaic.

Each of the plurality of pixels P may emit light of various brightness and various colors. In order to emit light of various colors, each of the plurality of pixels P may include sub-pixels P_{R}, P_{G}, and P_{B}.

The sub-pixels P_{R}, P_{G}, and P_{B} may include a red sub-pixel P_{R} capable of emitting red light, a green sub-pixel P_{G} capable of emitting green light, and a blue sub-pixel P_{B} capable of emitting blue light. For example, the red light may represent light having a wavelength of approximately 620 nanometers (nm) to approximately 750 nm. For another example, the green light may represent light having a wavelength of approximately 495 nm to approximately 570 nm. For yet another example, the blue light may represent light having a wavelength of approximately 450 nm to approximately 495 nm.

By combining the red light of the red sub-pixel P_{R}, the green light of the green sub-pixel P_{G}, and the blue light of the blue sub-pixel P_{B}, each of the plurality of pixels P may emit light of various brightness and various colors.

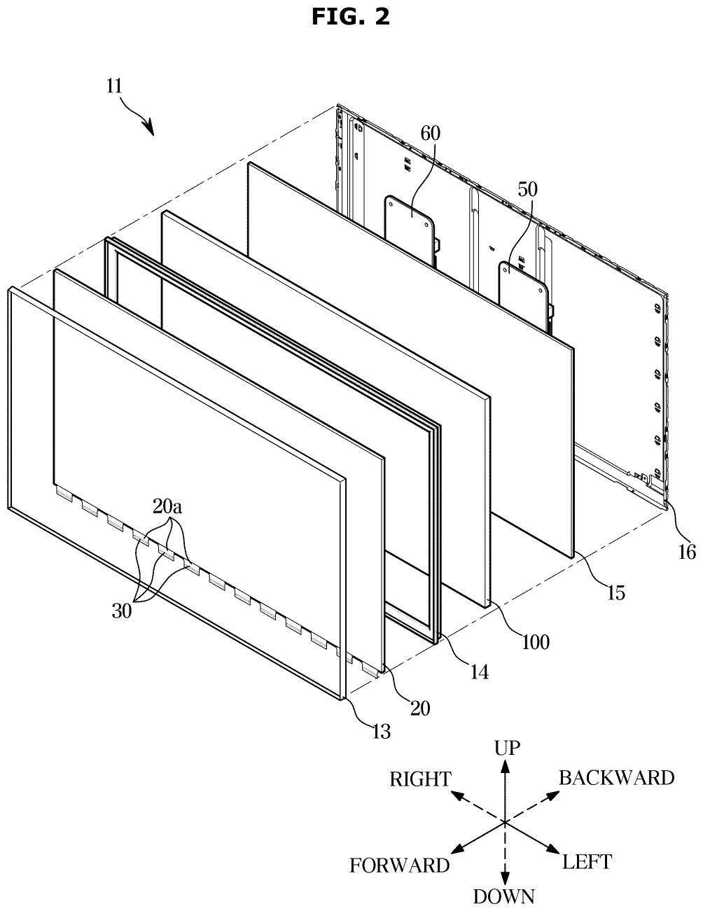

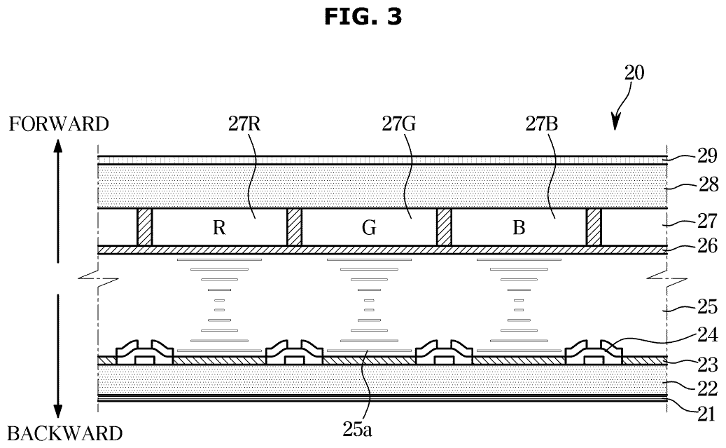

FIG. 2 is a view illustrating an example of a structure of a display apparatus 10, according to an embodiment. FIG. 3 is a view illustrating an example of a liquid crystal panel included in a display apparatus 10, according to an embodiment.

As shown in FIG. 2, various components for generating the image I on the screen 12 may be provided in the body 11.

For example, the body 11 may include a BLU 100, which may be a surface light source, a liquid crystal panel 20 configured to block and/or transmit light emitted from the BLU 100, a control assembly 50 configured to control operations of the BLU 100 and the liquid crystal panel 20, and a power supply assembly 60 configured to supply power to the BLU 100 and the liquid crystal panel 20. Alternatively or additionally, the body 11 may include a bezel 13, a frame middle mold 14, a bottom chassis 15, and a rear cover 16 for supporting the liquid crystal panel 20, the BLU 100, the control assembly 50, and the power supply assembly 60.

The BLU 100 may include a point light source that may emit a monochromatic light and/or a white light. Alternatively or additionally, the BLU 100 may refract, reflect, and/or scatter the light to convert the light emitted from the point light source into a uniform surface light. The BLU 100 may refract, reflect, and/or scatter the light emitted from the point light source to emit the uniform surface light in a forward direction. The BLU 100 may be described in more detail below.

The liquid crystal panel 20 may be provided in front of the BLU 100. In an embodiment, the liquid crystal panel 20 may block and/or transmit (e.g., pass through) light emitted from the BLU 100 to form the image I.

A front surface of the liquid crystal panel 20 may form the screen 12 of the display apparatus 10. Alternatively or additionally, the liquid crystal panel 20 may include the plurality of pixels P. The plurality of pixels P included in the liquid crystal panel 20 may independently block and/or transmit (e.g., pass through) the light emitted from the BLU 100. In an embodiment, the light transmitted through the plurality of pixels P may form the image I to be displayed on the screen 12.

For example, as shown in FIG. 3, the liquid crystal panel 20 may include a first polarizing film 21, a first transparent substrate 22, a pixel electrode 23, a thin-film transistor (TFT) 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the TFT 24, the liquid crystal layer 25, the common electrode 26, and the color filter 27. In an embodiment, the first transparent substrate 22 and the second transparent substrate 28 may be formed of tempered glass and/or transparent resin, for example. However, the present disclosure may not be limited in this regard. That is, the first transparent substrate 22 and the second transparent substrate 28 may be formed of other materials and/or combinations of materials without deviating from the scope of the present disclosure.

The first polarizing film 21 and the second polarizing film 29 may be provided on outer sides of the first and second transparent substrates 22 and 28, respectively. The first polarizing film 21 and the second polarizing film 29 may transmit specific polarized light and block (e.g., reflect and/or absorb) the other polarized light, respectively. For example, the first polarizing film 21 may transmit light polarized in a first direction and block (e.g., reflect and/or absorb) the other polarized light (e.g., light polarized in a second direction). Alternatively or additionally, the second polarizing film 29 may transmit light polarized in a second direction and block (e.g., reflect and/or absorb) the other polarized light (e.g., light polarized in the first direction). That is, the first direction and the second direction may be orthogonal to each other. Thus, the polarized light passing through the first polarizing film 21 may not directly pass through the second polarizing film 29.

The color filter 27 may be provided on an inner side of the second transparent substrate 28. The color filter 27 may include a red filter 27R configured to transmit red light, a green filter 27G configured to transmit green light, and a blue filter 27B configured to transmit blue light. Alternatively or additionally, the red filter 27R, the green filter 27G, and the blue filter 27B may be disposed parallel to each other. In an embodiment, a region occupied by the color filter 27 may correspond to the pixel P described above. For example, a region occupied by the red filter 27R may correspond to the red sub-pixel P_{R}, a region occupied by the green filter 27G may correspond to the green sub-pixel P_{G}, and a region occupied by the blue filter 27B may correspond to the blue sub-pixel P_{B}.

The pixel electrode 23 may be provided on an inner side of the first transparent substrate 22. Alternatively or additionally, the common electrode 26 may be provided on the inner side of the second transparent substrate 28. The pixel electrode 23 and the common electrode 26 may be formed of a metal material through which electricity may be conducted and may generate an electric field for changing the arrangement of liquid crystal molecules 25a constituting the liquid crystal layer 25.

The TFT 24 may be provided on the inner side of the first transparent substrate 22. The TFT 24 may be turned on (e.g., closed) or off (e.g., opened) by image data provided from a panel driver 30. Alternatively or additionally, by turning the TFT 24 on (e.g., closing) and/or off (e.g., opening), an electric field may be formed and/or removed from between the pixel electrode 23 and the common electrode 26.

The liquid crystal layer 25 may be formed between the pixel electrode 23 and the common electrode 26 and may be filled with the liquid crystal molecules 25a. The liquid crystal layer 25 may represent an intermediate state between a solid (e.g., a crystal) and a liquid. In an embodiment, the liquid crystal layer 25 may exhibit optical properties depending on a change of the electric field. For example, an arrangement direction of the liquid crystal molecules 25a constituting the liquid crystal layer 25 may change depending on the change of the electric field. As a result, optical properties of the liquid crystal layer 25 may change according to the presence and/or absence of the electric field passing through the liquid crystal layer 25. For example, the liquid crystal layer 25 may rotate a polarization direction of light about an optical axis according to the presence and/or absence of the electric field. Accordingly, the polarized light that has passed through the first polarizing film 21 may be changed in polarization direction while passing through the liquid crystal layer 25 and may pass through the second polarizing film 29.

A cable 20a through which image data may be transmitted to the liquid crystal panel 20 and a display driver integrated (DDI) circuit 30 (hereinafter, referred to as the “panel driver”) configured to process digital image data and output an analog image signal are provided on one side of the liquid crystal panel 20.

The cable 20a may electrically connect between the control assembly 50 and/or the power supply assembly 60 and the panel driver 30. The cable 20a may also electrically connect between the panel driver 30 and the liquid crystal panel 20. The cable 20a may include, but not be limited to, a flexible flat cable, a film cable, and the like, that may be bendable.

The panel driver 30 may receive image data and/or power from the control assembly 50 and/or the power supply assembly 60 through the cable 20a. Alternatively or additionally, the panel driver 30 may provide image data and/or driving current to the liquid crystal panel 20 through the cable 20a.

In an embodiment, the cable 20a and the panel driver 30 may be integrally implemented as a film cable, a chip on film (COF), a tape carrier package (TCP), or the like. That is, the panel driver 30 may be disposed on the cable 20a. However, the present disclosure may not be limited in this regard. For example, the panel driver 30 may be disposed on the liquid crystal panel 20.

The control assembly 50 may include a control circuit configured to control operations of the liquid crystal panel 20 and the BLU 100. For example, the control circuit may process a video signal and/or an audio signal received from an external content source, transmit the image data to the liquid crystal panel 20, and transmit dimming data to the BLU 100.

The power supply assembly 60 may include a power supply circuit configured to supply power to the liquid crystal panel 20 and the BLU 100. The power supply circuit may supply power to the control assembly 50, the BLU 100, and the liquid crystal panel 20.

The control assembly 50 and the power supply assembly 60 may be implemented with a printed circuit board and various circuits mounted on the printed circuit board. For example, the power supply circuit of the power supply assembly 60 may include a condenser, a coil, a resistance element, a processor, and the like and/or a power supply circuit board on which these elements are mounted (not shown). Alternatively or additionally, the control circuit of the control assembly 50 may include a memory, a processor, and/or a control circuit board on which these elements are mounted.

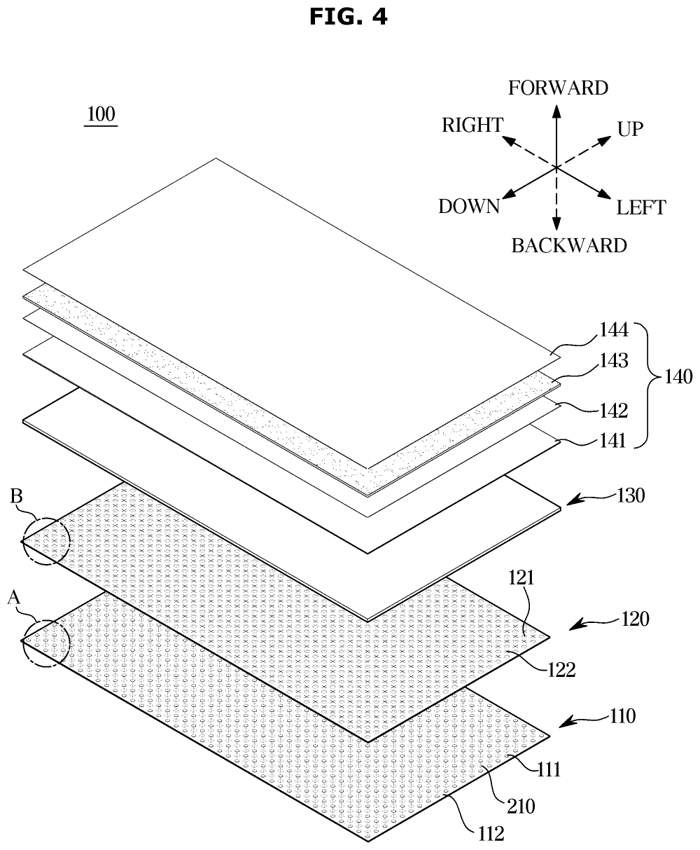

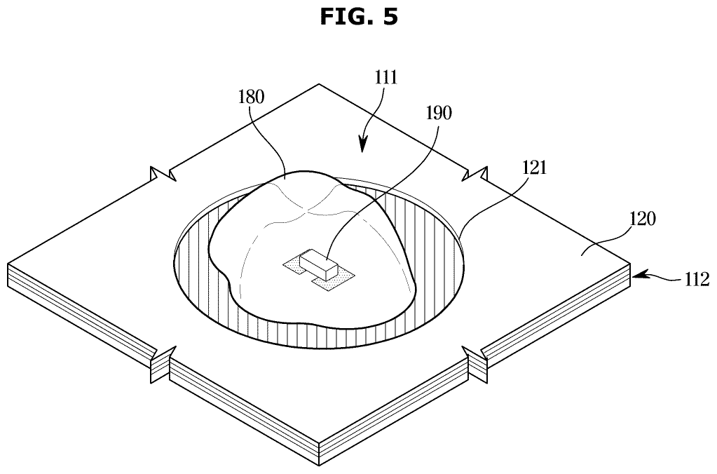

FIG. 4 is an exploded view illustrating a BLU 100, according to an embodiment. FIG. 5 is a schematic view illustrating an example of a light source included in a BLU 100 according to an embodiment.

As shown in FIG. 4, the BLU 100 may include a light source module 110 generating light, a reflector sheet 120 reflecting light, a composite sheet 140 uniformly diffusing incident light and improving the luminance of output light, and an adhesive layer 130 disposed between the composite sheet 140 and the reflector sheet 120.

The BLU 100, according to an embodiment, may not include a diffuser plate. Alternatively or additionally, the BLU 100 may include the composite sheet 140 that may be thinner than the diffuser plate. Similar to the diffuser plate, the composite sheet 140 may be provided to uniformly diffuse light incident on the composite sheet 140. Since the thickness of the composite sheet 140 may be thinner than that of the diffuser plate, the thickness of the BLU 100, according to an embodiment, may be reduced.

The light source module 110 may include a plurality of light sources 111 configured to emit light, a substrate 112 on which the plurality of light sources 111 are mounted, and a protrusion 210 protruding from the substrate 112.

The plurality of light sources 111 may be arranged in a predetermined pattern such that light may be emitted with uniform luminance. For example, the plurality of light sources 111 may be arranged such that the distance between one light source and each light source adjacent thereto may be the same.

In an embodiment, as shown in FIG. 4, the plurality of light sources 111 may be aligned in rows and columns. Accordingly, the plurality of light sources may be arranged to form an approximate square by four adjacent light sources. In such an embodiment, any one light source may be disposed adjacent to up to four light sources, and distances between the one light source and each of the adjacent light sources adjacent may be substantially the same.

The arrangement of the plurality of light sources 111 may not be limited to the arrangement described above, and the plurality of light sources 111 may be arranged in various ways such that light may be emitted with uniform luminance.

In an embodiment, the plurality of light sources 111 may employ an element configured to emit a monochromatic light (e.g., a light having a specific range of wavelengths and/or a light with one peak wavelength, such as, but not limited to, a blue light) and/or a white light (e.g., a light having a plurality of peak wavelengths, such as, but not limited to, a mixed light of red light, green light, and blue light) in various directions when power may be supplied to the element.

As shown in FIG. 5, each of the plurality of light sources 111 may include a light-emitting diode (LED) 190 and a refractive cover 180.

In order to reduce the thickness of the display apparatus 10, the thickness of the BLU 100 may also be reduced. In order to reduce the thickness of the BLU 100, a thickness of each of the plurality of light sources 111 may be reduced and a structure thereof may be simplified.

In an embodiment, the LED 190 may be directly attached to the substrate 112 in a chip on board (COB) manner. For example, the light source 111 may include the LED 190 in which an LED chip and/or an LED die may be directly mounted on the substrate 112 without separate packaging.

In an optional or additional embodiment, the LED 190 may be manufactured as a flip-chip type LED. In the flip-chip type LED 190, when a LED, which may be a semiconductor element, may be attached to the substrate 112, an electrode pattern of the semiconductor element may be directly fused to the substrate 112 without using an intermediate medium, such as a metal lead (wire) and/or a ball grid array (BGA). Since the metal lead (wire) and/or BGA may be omitted, the light source 111 including the flip-chip type LED 190 may be miniaturized (e.g., reduced in size when compared to other related LEDs).

In an embodiment, the refractive cover 180 may cover at least a portion of the LED 190. The refractive cover 180 may prevent and/or suppress damage to the LED 190 due to an external mechanical action, a chemical action, and/or an electric action.

In an optional or additional embodiment, the refractive cover 180 may be provided in a substantially domed shape in which a central portion may be formed concavely. Alternatively or additionally, the refractive cover 180 may increase a beam angle of a portion of light distribution having a high light intensity in the center of the LED 190. That is, the refractive cover 180 may reduce a hot spot in the center of the LED 190, which may increase a pitch (e.g., distance) between the LEDs 190. Consequently, the number of LEDs 190 in the BLU 100 may be increased.

In an embodiment, the refractive cover 180 may be formed by dispensing transparent material in a liquid state at a plurality of points and curing the transparent material. For example, the refractive cover 180 may be formed by dispensing transparent material in a liquid state at four points on the LEDs 190 and curing the transparent material. In an optional or additional embodiment, the transparent material in a liquid state may have a higher refractive index than air.

For example, the refractive cover 180 may be formed of a silicone and/or epoxy resin. In such an example, a molten silicone and/or epoxy resin may be discharged onto the LED 190 through a nozzle or the like, and then the discharged silicone and/or epoxy resin may be cured to form the refractive cover 180.

In an embodiment, the refractive cover 180 may be optically transparent and/or semi-transparent. Alternatively or additionally, the refractive cover 180 may be disposed such that the light emitted from the LED 190 may be emitted to the outside through the refractive cover 180. Although the description above describes forming the refractive cover 180 using two possible materials, it may be understood that other materials and/or combinations of materials may be used without departing from the scope of the present disclosure. That is, the refractive cover 180 may be formed of other combinations of materials that may provide an optically transparent and/or semi-transparent cover that may permit light emitted from the LED 190 to pass through and/or that may prevent and/or suppress damage to the LED 190.

In an embodiment, the dome-shaped refractive cover 180 may refract light like a lens. For example, the light emitted from the LED 190 may be diffused by being refracted by the refractive cover 180. That is, the refractive cover 180 may prevent and/or suppress damage to the LED 190 due to an external mechanical action, a chemical action, and/or an electric action, while diffusing the light emitted from the LED 190. Alternatively or additionally, the light emitted from the LED 190 may be focused by the refractive cover 180.

The substrate 112 may fix the plurality of light sources 111 such that the positions of the light sources 111 may not be changed. Alternatively or additionally, the substrate 112 may supply each light source 111 with power for the light source 111 to emit light.

In some embodiments, the substrate 112 may be formed of at least one of a synthetic resin, a tempered glass, and a printed circuit board (PCB) on which a conductive power supply line for supplying power to the light source 111 has been formed. However, the present disclosure may not be limited in this regard, and the substrate 112 may be formed of other materials and/or combinations of materials.

In an embodiment, the LED 190 may be provided as a plurality of LEDs 190 on the upper surface of the substrate 112 to form an array, and the refractive cover 180 may be provided as a plurality of refractive covers that correspond, respectively, to the plurality of LEDs 190.

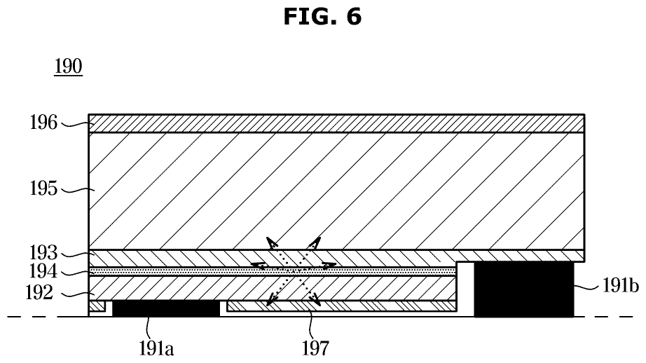

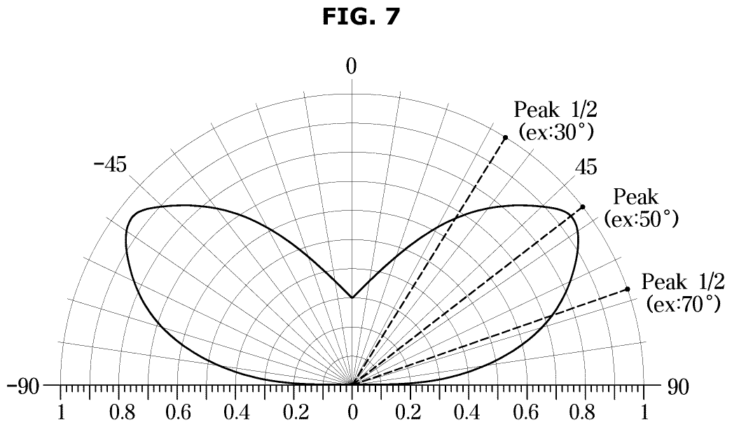

FIG. 6 is a view illustrating an example of a LED included in a BLU 100, according to an embodiment. FIG. 7 is a view illustrating the intensity of light emitted from the LED 190 of FIG. 6 according to emission angles, according to an embodiment.

Referring to FIG. 6, the LED 190 may include a transparent substrate 195, an n-type semiconductor layer 193, and a p-type semiconductor layer 192. In addition, a multi-quantum well (MQW) layer 194 may be formed between the n-type semiconductor layer 193 and the p-type semiconductor layer 192.

The transparent substrate 195 may be a base of a p-n junction capable of emitting light. For example, the transparent substrate 195 may include, but not be limited to, sapphire (Al₂O₃) including a crystal structure similar to that of the semiconductor layers 193 and 192.

As the n-type semiconductor layer 193 and the p-type semiconductor layer 192 are bonded to each other, a p-n junction may be implemented. A depletion region may be formed between the n-type semiconductor layer 193 and the p-type semiconductor layer 192. In the depletion layer, electrons of the n-type semiconductor layer 193 and holes of the p-type semiconductor layer 192 may recombine. Light may be emitted by recombination of electrons and holes.

For example, the n-type semiconductor layer 193 may include n-type gallium nitride (n-type GaN). Alternatively or additionally, the p-type semiconductor layer 192 may also include p-type gallium nitride (p-type GaN). An energy band gap of gallium nitride (GaN) may be approximately 3.4 electronVolts (eV), which may emit light with a wavelength shorter than 400 nm. Accordingly, deep blue and/or ultraviolet light may be emitted from the junction of the n-type semiconductor layer 193 and the p-type semiconductor layer 192.

The n-type semiconductor layer 193 and the p-type semiconductor layer 192 are not limited to gallium nitride, and various semiconductor materials may be used according to light that may be required according to design constraints.

A first electrode 191a of the LED 190 may be in electrical contact with the p-type semiconductor layer 192, and a second electrode 191b of the LED 190 may in electrical contact with the n-type semiconductor layer 193. The first electrode 191a and the second electrode 191b may function as electrodes but also as reflectors that reflect light.

When a voltage may be applied to the LED 190, holes may be supplied to the p-type semiconductor layer 192 through the first electrode 191a, and electrons may be supplied to the n-type semiconductor layer 193 through the second electrode 191b. The electrons and holes may recombine in the depletion layer formed between the p-type semiconductor layer 192 and the n-type semiconductor layer 193. When electrons and holes recombine in the depletion layer, energy (e.g., kinetic energy and/or potential energy) of electrons and holes may be converted into light energy. That is, when electrons and holes recombine, light may be emitted.

In an embodiment, the energy band gap of the MQW layer 194 may less than that of the p-type semiconductor layer 192 and/or the n-type semiconductor layer 193. Consequently, holes and electrons may be trapped in the MQW layer 194. The holes and electrons trapped in the MQW layer 194 may easily recombine with each other in the MQW layer 194. Accordingly, efficiency of light generation of the LED 190 may be improved when compared to related LEDs.

Light having a wavelength corresponding to the energy gap of the MQW layer 194 may be emitted from the MQW layer 194. For example, blue light between approximately 420 nm and approximately 480 nm may be emitted from the MQW layer 194. That is, the MQW layer 194 may correspond to a light emitting layer configured to emit blue light.

Light generated by recombination of electrons and holes may not be emitted in a specific direction, and may be emitted in all directions as shown in FIG. 6. However, in the case of light emitted from a surface, such as the MQW layer 194, the intensity of light emitted in a direction perpendicular to a light emitting surface may be greatest and the intensity of light emitted in a direction parallel to the light emitting surface may be smallest.

A first reflective layer 196 may be disposed on an outer side (e.g., an upper side of the transparent substrate 195 of FIG. 6) of the transparent substrate 195. That is, the first reflective layer 196 may be disposed on the upper side of the MQW layer 194. Alternatively or additionally, a second reflective layer 197 may be disposed on an outer side (e.g., a lower side of the p-type semiconductor layer 192 of FIG. 6) of the p-type semiconductor layer 192. Accordingly, the transparent substrate 195, the n-type semiconductor layer 193, the MQW layer 194, and the p-type semiconductor layer 192 may be disposed between the first reflective layer 196 and the second reflective layer 197.

In an embodiment, the first reflective layer 196 and the second reflective layer 197 may each reflect a part of the incident light, and pass another part of the incident light. For example, the first reflective layer 196 and the second reflective layer 197 may reflect light having a wavelength included in a specific wavelength range, and pass light having a wavelength outside the specific wavelength range. For example, the first reflective layer 196 and the second reflective layer 197 may reflect blue light having a wavelength between approximately 420 nm and approximately 480 nm emitted from the MQW layer 194. Alternatively or additionally, the first reflective layer 196 and the second reflective layer 197 may reflect incident light having a specific incident angle, and transmit light outside the specific incident angle.

In an embodiment, the first reflective layer 196 and the second reflective layer 197 may include distributed Bragg reflector (DBR) layers formed by laminating materials having different refractive indices so as to have various refractive indices according to incident angles. For example, the first reflective layer 196 may reflect light incident at a small incident angle, and/or pass light incident at a large incident angle. Alternatively or additionally, the second reflective layer 197 may reflect and/or pass light incident at a small incident angle, and/or reflect light incident at a large incident angle. The incident light may be, for example, blue light having a wavelength between approximately 420 nm and approximately 480 nm.

The intensity of light emitted in a direction perpendicular to the upper surface of the LED 190 (e.g., in a direction toward an upper side of the LED 190 in FIG. 6) may be less than the intensity of light emitted in a direction inclined with respect to the upper surface of the LED 190 (e.g., a direction inclined by 40 degrees (°) to 60° with respect to the direction toward the upper side of the LED 190 in the drawing).

In an embodiment, the beam angle of light emitted in the direction perpendicular to the upper surface of the LED 190 may be referred to as 0°. Alternatively or additionally, the beam angle of light emitted in a direction inclined with respect to the upper surface of the LED 190 may be defined as having a beam angle greater than 0° and less than or equal to 90°.

In an embodiment, the intensity of light emitted at an angle of approximately 400 to approximately 600 with respect to the vertical axis of the LED 190 may be greater (e.g., greater) than the intensity of light emitted at other angles (e.g., less than 400 and/or greater than 60°). For example, the LED 190 may have a peak light intensity at a point in which the beam angle may be approximately 50°. That is, among the light emitted from the LED 190, light having a beam angle of 50° may have the greatest intensity.

Alternatively or additionally, in a region in which the LED 190 has a beam angle lower than the beam angle of the peak light intensity, the LED 190 may have light intensity corresponding to half of the peak light intensity. For example, the LED 190 may have light intensity (e.g., ½ of peak) corresponding to half of the peak light intensity at a point in which the beam angle may be 30°.

In an embodiment, in a region in which the LED 190 has a beam angle higher than the beam angle of the peak light intensity, the LED 190 may have light intensity corresponding to half of the peak light intensity. For example, the LED 190 may have light intensity (e.g., ½ of peak) corresponding to half of the peak light intensity at a point in which the beam angle may be 70°.

In an embodiment, the LED 190 may have a light profile of an approximate bat wing shape. That is, the light profile of the bat wing shape may represent a light profile in which the intensity of light emitted in an oblique direction (e.g., a direction having an angular interval of approximately 40° to approximately 60° from the vertical axis perpendicular to the light emitting surface) may be greater than the intensity of light emitted in a direction perpendicular to the MQW layer 194.

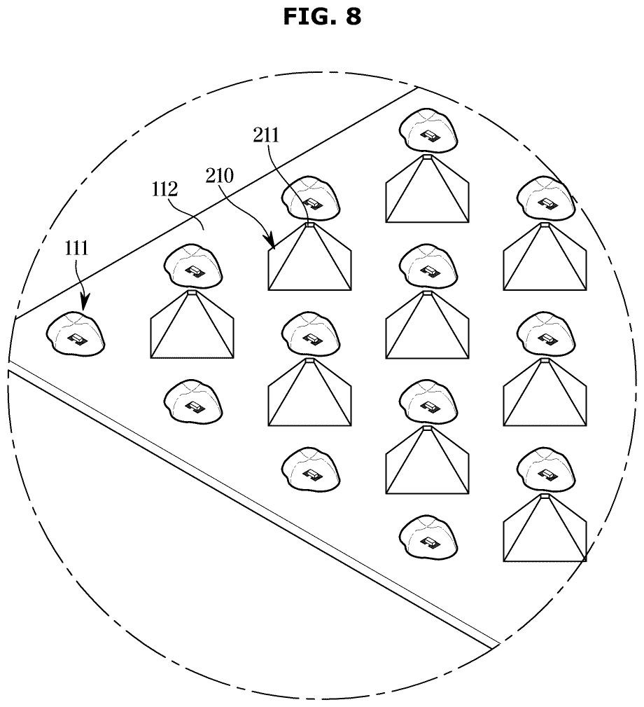

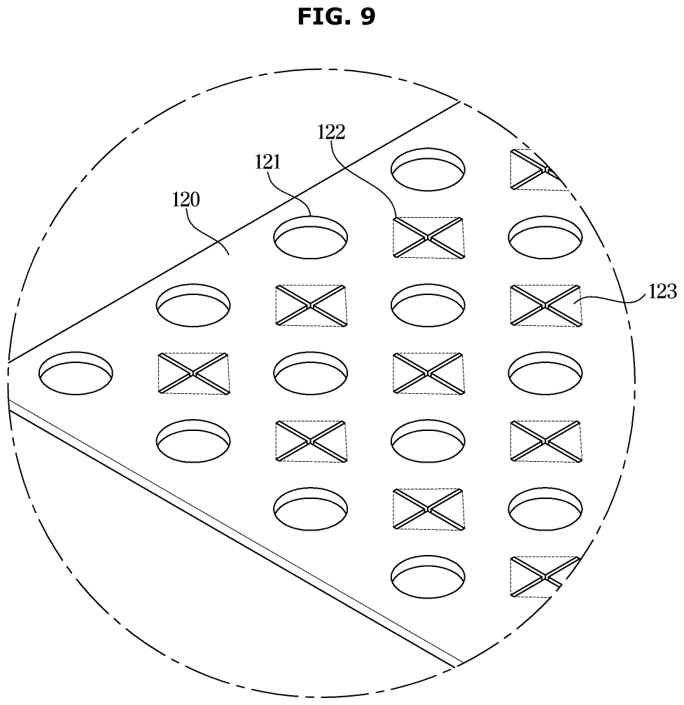

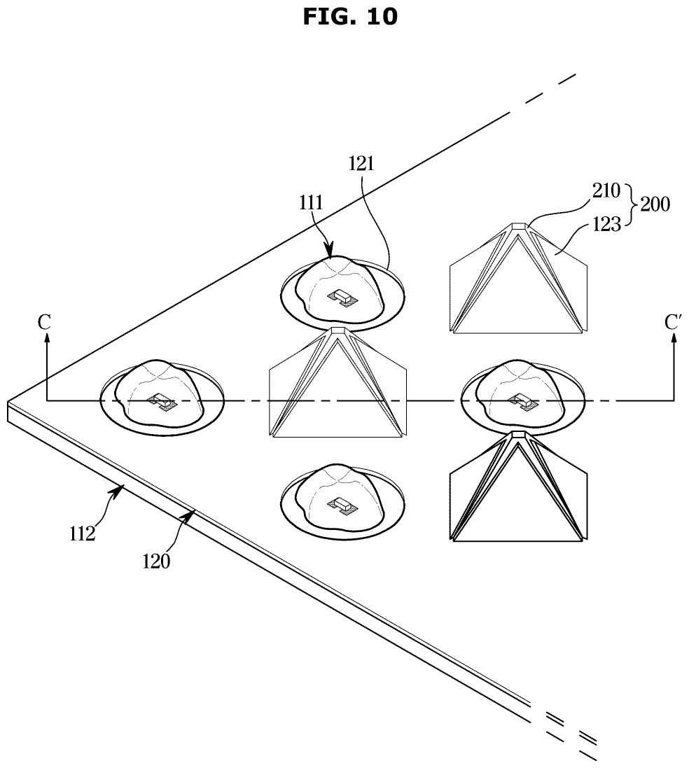

FIG. 8 is an enlarged view of part A of FIG. 4, according to an embodiment. FIG. 9 is an enlarged view of part B of FIG. 4, according to an embodiment. FIG. 10 is a view illustrating a state in which a reflector sheet may be disposed on a light source module in a BLU 100, according to an embodiment.

Referring to FIGS. 8 to 10, the light source module 110 may include a plurality of protrusions 210 protruding forward from the substrate 112. As the reflector sheet 120 may be disposed on the plurality of protrusions 210, a plurality of reflectors 200 that reflect light emitted from the plurality of light sources 111 forward and/or in a direction close to the forward direction may be formed.

The reflector sheet 120 may allow light emitted from the plurality of light sources 111 to be reflected forward and/or in a direction similar to the forward direction.

The reflector sheet 120 may include a plurality of through holes 121 corresponding respectively to the plurality of light sources 111 of the light source module 110. The plurality of light sources 111 may pass through the through holes 121 and protrude forward of the reflector sheet 120. With such an arrangement, the plurality of light sources 111 may emit light at the front of the reflector sheet 120. The reflector sheet 120 may allow light emitted from the plurality of light sources 111 toward the reflector sheet 120 to be reflected toward the composite sheet 140.

The reflector sheet 120 may include a plurality of cutouts 122 corresponding, respectively, to the plurality of protrusions 210 of the light source module 110. The plurality of cutouts 122 may each be formed by cutting a portion of the reflector sheet 120. The plurality of cutouts 122 may each be provided in a shape corresponding to edges of each of the plurality of protrusions 210. For example, the plurality of cutouts 122 may each be provided in a cross (e.g., +) shape.

The reflector sheet 120 may include a plurality of protrusion covers 123 provided to cover the plurality of protrusions 210, as one area of the reflector sheet 120. The reflector sheet 120 may be coupled and/or attached to the substrate 112 such that the plurality of cutouts 122 are positioned on the plurality of protrusions 210. As the reflector sheet 120 may be coupled or attached to the substrate 112, the plurality of reflectors 200 may be formed.

The adhesive layer 130 and the composite sheet 140 may be provided in front of the light source module 110 and the reflector sheet 120. The composite sheet 140 may evenly disperse light emitted from the light source 111 of the light source module 110 and improve the luminance of light incident to the composite sheet 140 and uniformity of the luminance.

The composite sheet 140 may include various sheets for diffusing light incident thereto and improving luminance of the light and uniformity of the luminance. For example, the composite sheet 140 may include at least one of a reflector sheet 141 provided to selectively reflect incident light, a diffuser sheet 142 provided to diffuse incident light, a light conversion sheet 143 provided to convert a wavelength of incident light, or a prism sheet 143 including a prism pattern.

The composite sheet 140 may not be limited to the sheet and/or film shown in FIG. 4 and may include more diverse sheets and/or films, such as a protective sheet.

The adhesive layer 130 may be provided on one surface of the composite sheet 140. The adhesive layer 130 may be provided between the composite sheet 140 and the reflector sheet 120. The adhesive layer 130 may allow the composite sheet 140 to be bonded to the plurality of reflectors 200. The composite sheet 140 may be coupled to the light source module 110 by the adhesive layer 130 without a separate structure.

Referring to FIG. 8, the light source module 110 may include a substrate 112, a plurality of light sources 111 mounted on the substrate 112, and a plurality of protrusions 210 protruding from the substrate 112.

According to one embodiment, each of the plurality of protrusions 210 may substantially take a form of a frustum of square pyramid. For example, the protrusion 210 may be provided in a quadrangular pyramid shape with a flat vertex. The protrusion 210 may include an adhesive surface 211 forming an upper surface thereof to increase a contact area with the adhesive layer 130. The protrusion 210 may include four side surfaces, which may be disposed to face the plurality of light sources 111, respectively. Due to the arrangement of the protrusions 210, reflective surfaces of the reflector 200 to be described below may be disposed to face the plurality of light sources 111, respectively. Since the reflective surfaces of the reflector 200 are disposed to face four light sources of the plurality of light sources 111 adjacent to the reflector 200, respectively, light emitted from the four light sources 111 may be reflected forward from the reflective surfaces of the reflector 200.

Referring to FIG. 9, the reflector sheet 120 may include a plurality of through holes 121 and a plurality of cutouts 122. The reflector sheet 120 may include a plurality of protrusion covers 123 as areas adjacent to the plurality of cutouts 122. The plurality of protrusion covers 123 may correspond respectively to the plurality of cutouts 122.

Referring to FIG. 10, each of the plurality of light sources 111 may protrude forward of the reflector sheet 120 through the corresponding through hole 121.

Each of the plurality of protrusion covers 123 may cover one of the plurality of protrusions 210 corresponding thereto. As each of the plurality of protrusion covers 123 covers the corresponding one of the plurality of protrusions 210, the plurality of protrusions 210 and the plurality of protrusion covers 123 may form a plurality of reflectors 200. A reflector 200 may include a protrusion 210 forming the structural appearance thereof, and a plurality of reflective surfaces provided to cover the outer surface of the protrusion 210 and reflect light. As a plurality of protrusion covers 123 cover a plurality of protrusions 210 corresponding thereto, a plurality of reflective surfaces may be formed.

Through the plurality of cutouts 122, at least a portion of the plurality of protrusions 210 may pass through the reflector sheet 120. Since the plurality of cutouts 122 are provided, the plurality of protrusions 210 may protrude toward the front of the reflector sheet 120. For example, the adhesive surfaces 211 of the plurality of protrusions 210 may pass through the reflector sheet 120 and protrude toward the front of the reflector sheet 120. The cutout 122 may be provided in a shape corresponding to edges of the protrusion 210. For example, the cutout 122 may be provided in a substantially cross (e.g., +) shape to correspond to four edges of the protrusion 210 provided in the shape of a quadrangular pyramid and/or a frustum of a square pyramid.

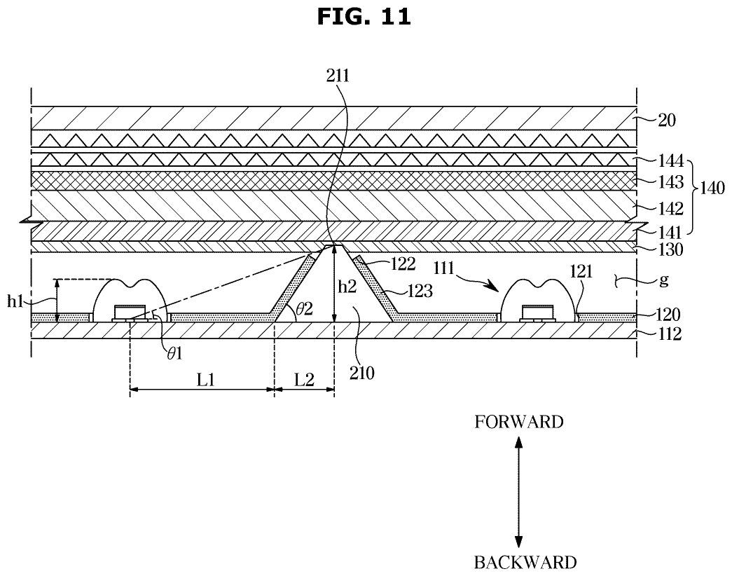

FIG. 11 is a cross sectional view of a liquid crystal panel and a BLU 100 taken along line C-C′ of FIG. 10 in a display apparatus, according to an embodiment.

In FIG. 11, a cross section of one of the plurality of reflectors 200, two light sources 111 adjacent to the reflector 200, an adhesive layer 130, a composite sheet 140, and a liquid crystal panel are schematically shown. The reflector 200 may include a protrusion 210 and a protrusion cover 123 covering side surfaces of the protrusion 210.

Referring to FIG. 11, the BLU 100, according to an embodiment, may not include a diffuser plate. Alternatively or additionally, the BLU 100 may include the composite sheet 140 that may be thinner than the diffuser plate. With such a configuration, the thickness of the BLU 100 may be reduced when compared to related display apparatuses. Similar to the diffuser plate, the composite sheet 140 may include a diffuser sheet 142 that uniformly diffuses light incident on the composite sheet 140. The composite sheet 140 may include a reflector sheet 141 that selectively transmits and/or reflects light according to a beam angle of incident light. The composite sheet 140 may include a light conversion sheet 143 provided to convert a wavelength of incident light. The composite sheet 140 may include a prism sheet 144 including a prism pattern.

The composite sheet 140 may be coupled to the light source module 110 by the adhesive layer 130. That is, by the adhesive force of the adhesive layer 130, the adhesive surfaces 211 of the plurality of protrusions 210 and the composite sheet 140 may be coupled so as not to be separated from each other. As the adhesive surfaces 211 of the plurality of protrusions 210 come in contact with the adhesive layer 130 provided on one surface of the composite sheet 140, the composite sheet 140 may be attached to the plurality of reflectors 200. In other words, the composite sheet 140 may be attached and/or coupled to the light source module 110.

As the plurality of reflectors 200 are attached to the composite sheet 140, the plurality of reflectors 200 may support the composite sheet 140. In an embodiment, the plurality of reflectors 200 may form an array having columns and rows. The plurality of reflectors 200 forming an array may stably support the composite sheet 140 such that the composite sheet 140 may not be structurally deformed. Alternatively or additionally, the plurality of reflectors 200 may be coupled to the composite sheet 140 through the adhesive layer 130 without a separate structure.

In a state in which the plurality of reflectors 200 are attached to the composite sheet 140 by the adhesive layer 130, the composite sheet 140 may be fixed while being spaced apart from the reflector sheet 120 by a predetermined distance. The plurality of reflectors 200 may support the composite sheet 140 such that a predetermined air gap g may be formed between the adhesive layer 130 and the reflector sheet 120. The air gap g may be formed between the reflector sheet 120 and the composite sheet 140, between the substrate 112 and the composite sheet 140, and/or between the substrate 112 and the adhesive layer 130.

In related display apparatuses, a diffuser plate may be supported by a plurality of supporters irregularly disposed on a substrate. For example, the positions and number of the supporters may be set as needed and, consequently, the supporters may be arranged irregularly. While such a plurality of irregularly disposed supporters may provide sufficient support to a diffuser plate having a relatively high hardness without deformation, attempting to support a composite sheet having a relatively low hardness may result in the composite sheet being deformed. Alternatively or additionally, since the reflector sheet may not be disposed in a portion of the substrate on which the supporter may be disposed, light efficiency of the related backlight unit may be reduced.

However, according to an embodiment, the plurality of reflectors 200 having a relatively low height compared to a related supporter may form an array and, as such, the composite sheet 140 may be supported without deformation. Since the plurality of reflectors 200 may have a low height, the thicknesses of the BLU 100 and the display apparatus 10 may be reduced when compared to related display apparatuses. In an embodiment, the plurality of reflectors 200 may form an array having rows and columns. The plurality of reflectors 200 may support the composite sheet 140 at a plurality of points arranged at equal intervals, thereby supporting the composite sheet 140 without deformation. Alternatively or additionally, the plurality of reflectors 200 may be attached to the adhesive layer 130 provided on one surface of the composite sheet 140 to thereby be coupled to the composite sheet 140 without a separate structure.

The plurality of reflectors 200 may allow light emitted from LEDs 190 adjacent thereto to be reflected forward, thereby removing and/or reducing dark areas of the BLU 100.

According to an embodiment, an elevation angle θ1 for determining the height of the reflector 200 may satisfy a relational expression using the following equation:

$$θ1 = {tan}^{- 1} ( \frac{h 2}{( L 1 + L 2 )} ) \qquad [ Equation 1 ]$$

Referring to Equation 1, h2 represents a distance from the substrate 112 to the highest point of the reflector 200 and/or the protrusion 210. L1 represents a distance from the center of the light source 111 and/or the LED 190 to a point at which the reflector 200 and/or the protrusion 210 protrudes from the substrate 112. L2 represents a distance between a point at which the reflector 200 and/or the protrusion 210 protrudes from the substrate 112 and a point at which the reflector 200 and/or the protrusion 210 has the maximum height and/or the center of a surface at having the maximum height.

According to an embodiment, an included angle θ2 between the reflective surface of the reflector 200 and the substrate 112 for determining the inclination of the reflective surface of the reflector 200 with respect to the substrate 112 may satisfy relational expression using the following equation:

$$θ2 = {tan}^{- 1} ( \frac{h 2}{L 2} ) \qquad [ Equation 2 ]$$

According to an embodiment, the distance h1 from the substrate 112 to the highest point of the light source 111 and the distance h2 from the substrate 112 to the highest point of the reflector 200 may satisfy a relational expression using the following equation:

h1<h2<3×h1 [Equation 3]

In an embodiment, θ1 may have a range between approximately 5° and 45° (e.g., 5°<θ1<45°) in consideration of the beam angle of light emitted from the light source 111 and the thickness of the BLU 100 and/or the display apparatus 10.

Alternatively or additionally, the angle θ2 may be less than 1.2 times θ1 (e.g., θ2>1.2×θ1) in consideration of the beam angle of light emitted from the light source 111 and the thickness of the BLU 100 and/or the display apparatus 10.

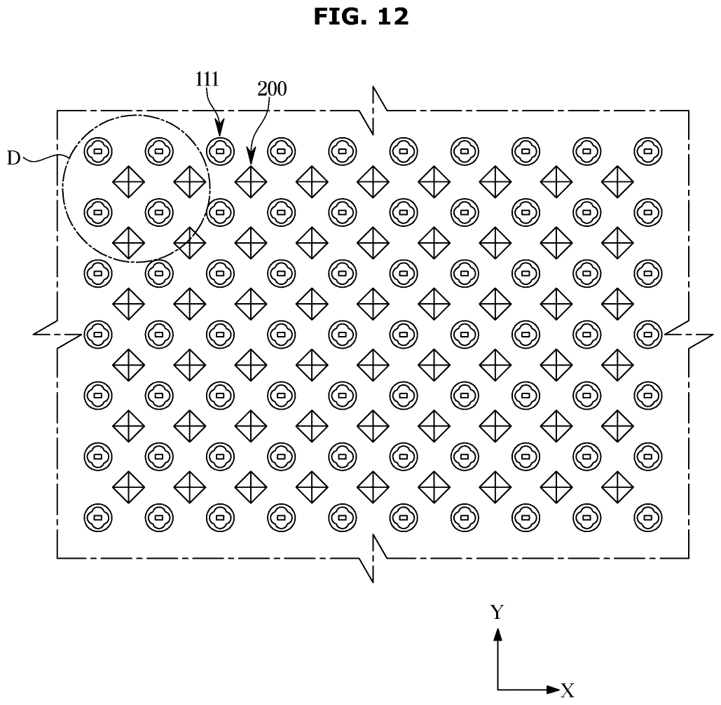

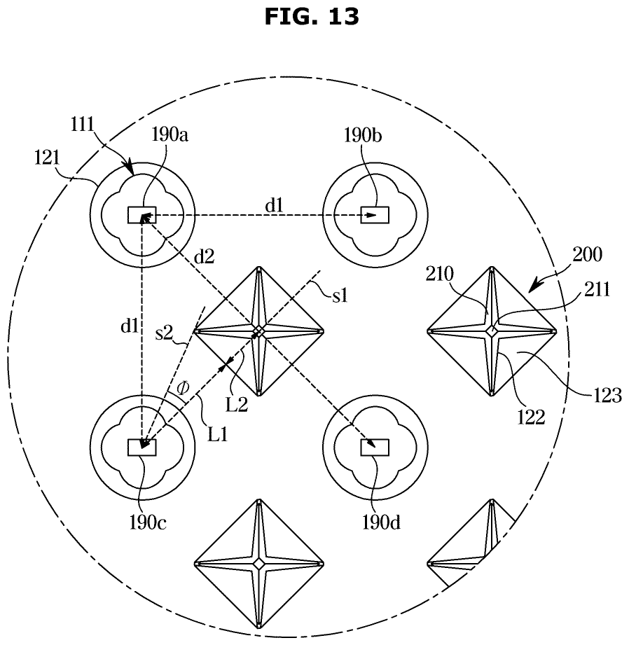

FIG. 12 is a view illustrating a light source module and a reflector sheet in a BLU 100, according to an embodiment. FIG. 13 is an enlarged view of part D of FIG. 12, according to an embodiment.

Referring to FIGS. 12 and 13, the arrangement of the plurality of light sources 111 and the plurality of reflectors 200 are described. In an embodiment, each of the plurality of light sources 111 may include the LED 190. Hereinafter, the description of the arrangement of the plurality of light sources 111 may be equally applied to the arrangement of the LEDs 190.

According to an embodiment, the plurality of light sources 111 may be spaced apart from each other at a first interval along a first direction on the substrate 112 (e.g., X direction). The plurality of light sources 111 may be arranged spaced apart from each other at the first interval along a second direction perpendicular to the first direction on the substrate 112 (e.g., Y direction). The first direction may indicate the X direction of FIG. 12. The second direction may indicate the Y direction of FIG. 12. However, the present disclosure may not be limited in this regard. For example, the first direction may indicate the Y direction of FIG. 12 and the second direction may indicate the X direction of FIG. 12.

The plurality of light sources 111 may be arranged to be spaced apart by the first interval in the first and second directions to form a light source array.

According to an embodiment, the plurality of reflectors 200 may be disposed between the plurality of light sources 111. The plurality of reflectors 200 may be disposed between the plurality of light sources 111 arranged spaced apart at a second interval along a third direction, which may be diagonal to the first and second directions. In an embodiment, the second interval may be greater than the first interval. Alternatively or additionally, the second interval may be less (e.g., smaller) than the first interval.

Referring to FIG. 13, the plurality of light sources 111 may include a first LED 190a, a second LED 190b spaced apart from the first LED 190a in the first direction by a first distance d1, and a third LED 190c spaced apart from the first LED 190a by the first distance d1 in the second direction. The plurality of light sources 111 may include a fourth LED 190d spaced apart from the first LED 190a by a second distance d2 in a third direction that may be diagonal to the first and second directions. The fourth LED 190d may be spaced apart from the second LED 190b in the second direction by the first distance d1. The fourth LED 190d may be spaced apart from the third LED 190c in the first direction by the first distance d1.

In an embodiment, the plurality of light sources 111 may be spaced apart from each other by the first distance d1 in the first direction and the second direction. The plurality of light sources 111 may be spaced apart from each other by the second distance d2 in the third direction that may be diagonal to the first and second directions. The second distance d2 may be greater than the first distance d1. The distance between two light sources 111 adjacent to each other in the first and second directions may be the first distance d1. Alternatively or additionally, the distance between two light sources 111 adjacent to each other in the third direction may be the second distance d2, which may be greater than the first distance d1. Due to the arrangement of the light sources 111, a dark area may occur in some area between two light sources 111 adjacent to each other in the third direction. In other words, dark mura may occur in the BLU 100.

The reflector 200 may be disposed between the first LED 190a and the fourth LED 190d and/or between the second LED 190b and the third LED 190c. The reflector 200 may be spaced apart from each of the first to fourth LEDs 190a, 190b, 190c, and 190d by half of the second distance d2 (e.g., ½×d2). In this case, half of the second distance d2 (e.g., ½×d2) may indicate the distance from the center of the LED 190 (e.g., first LED 190a, second LED 190b, third LED 190c, fourth LED 190d) to the center of the reflector 200.

In an embodiment, the plurality of reflectors 200 may be disposed between the plurality of light sources 111 disposed in the diagonal direction with reference to FIGS. 12 and 13. In an optional or additional embodiment, the plurality of reflectors 200 may form an array having rows and columns similar to the plurality of light sources 111.

By disposing the plurality of reflectors 200 between the plurality of light sources 111 disposed in the third direction, the dark mura of the BLU 100 may be potentially removed and/or reduced. Alternatively or additionally, the uniformity of luminance of the BLU 100 may be improved as the plurality of reflectors 200 may be disposed at positions in which the amount of light may be relatively insufficient, and the light emitted from the plurality of light sources 111 may be reflected forward, and thus the uniformity of luminance of the backlight unit 100 may be improved. The position in which the amount of light is relatively insufficient may indicate a region between the plurality of light sources 111 disposed along the third direction.

In an embodiment, the size of the bottom surface of the reflector 200 may be determined by an azimuthal angle θ. The azimuthal angle θ may refer to an angle between a first straight line s1 from any one LED 190, which may be adjacent to a reflector 200, to the center of the reflector 200 and a second straight line s2 connecting from the LED 190 to the outermost point of the reflector 200.

The size of the bottom surface of the reflector 200 may be determined by the angle Φ. According to an embodiment, the range of the azimuth angle Φ may be from approximately 5° to approximately 45° (e.g., 5°<Φ<45°) in consideration of the beam angle of light emitted from the light source 111 and the thickness of the BLU 100 and/or the display apparatus 10.

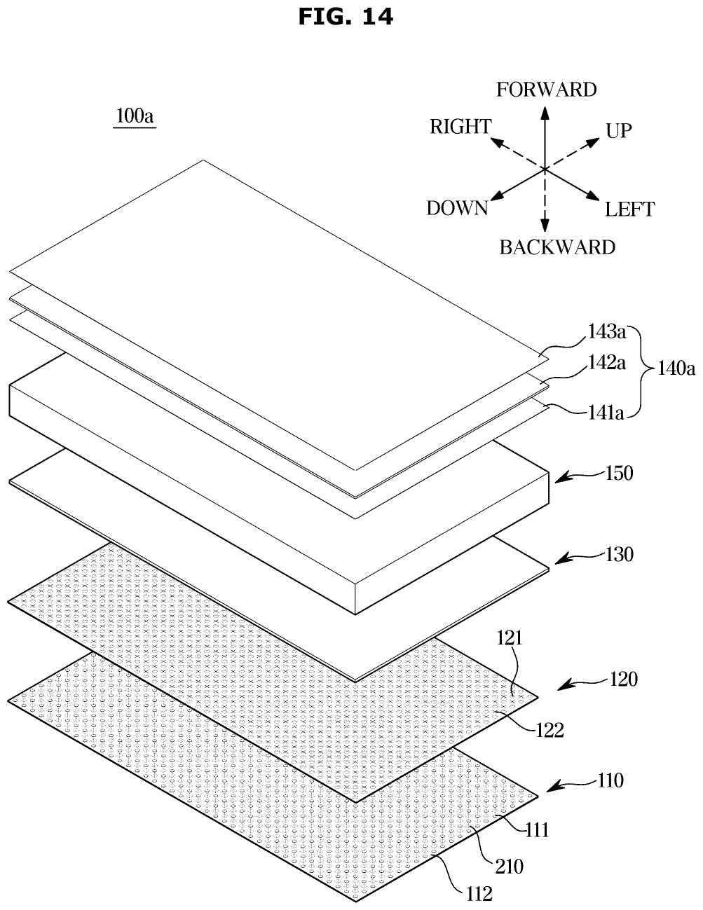

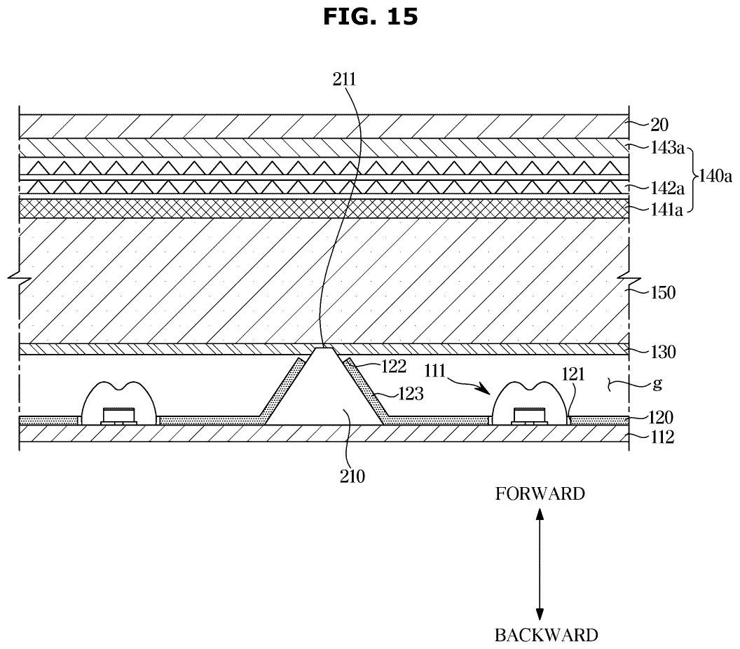

FIG. 14 is an exploded view of a BLU 100a, according to an embodiment. FIG. 15 is a cross-sectional view of a liquid crystal panel and a BLU 100a, according to an embodiment.

Referring to FIGS. 14 and 15, the BLU 100a, according to an embodiment, may include a diffuser plate 150.

The BLU 100a may include a light source module 110 generating light, a reflector sheet 120 reflecting light, a diffuser plate 150 uniformly diffusing light, an adhesive layer 130 provided on one surface of the diffuser plate 150, and an optical sheet 140a provided on the other side of the diffuser plate 150 and improving the luminance of the emitted light. The adhesive layer 130 may be disposed between the diffuser plate 150 and the light source module 110. The optical sheet 140a may be disposed between the diffuser plate 150 and the liquid crystal panel 20.

The diffuser plate 150 may diffuse light emitted from the plurality of light sources 111 within the diffuser plate 150 in order to reduce non-uniformity in luminance due to the plurality of light sources 111. That is, the diffuser plate 150 may diffuse non-uniform light emitted from the plurality of light sources 111 so that the light may be relatively uniformly emitted through the front surface thereof.

The optical sheet 140a may include various sheets for improving luminance and/or uniformity of the luminance. For example, the optical sheet 140a may include at least one of a light conversion sheet 141a, a prism sheet 142a, and a reflective polarizing sheet 143a.

Referring to FIG. 15, the diffuser plate 150 may be attached to the plurality of reflectors 200 by the adhesive layer 130 provided on one surface of the diffuser plate 150. The diffuser plate 150 may be coupled to the plurality of reflectors 200 by the adhesive force of the adhesive layer 130 without a separate structure. The plurality of reflectors 200 may stably support the diffuser plate 150 at a plurality of points. The plurality of reflectors 200 may support the diffuser plate 150 and the optical sheet 140a such that a predetermined air gap g may be formed between the adhesive layer 130 and the reflector sheet 120.

The diffuser plate 150 may diffuse the light emitted from the plurality of light sources 111 within the diffuser plate 150 in order to reduce non-uniformity in luminance due to the plurality of light sources 111. That is, the diffuser plate 150 may diffuse non-uniform light emitted from the plurality of light sources 111 so that the light may be relatively uniformly emitted through the front surface thereof.

The optical sheet 140a may include various sheets for improving luminance and/or uniformity of the luminance. For example, the optical sheet 140a may include a light conversion sheet 141a, a diffuser sheet (not shown), a prism sheet 142a, a reflective polarizing sheet 143a, and the like.

In a related display apparatus, a diffuser plate may be supported by a plurality of supporters irregularly disposed on a substrate. The plurality of supporters may have a relatively high height, which may be a factor of increasing the thickness of the related display apparatus or the related BLU. Alternative or additionally, since the reflector sheet may not be disposed in a portion of the substrate on which the supporter may be disposed, light efficiency of the related backlight unit may be reduced.

According to an embodiment, since the plurality of reflectors 200 having a relatively low height compared to the related plurality of supports supports the diffuser plate 150, the thicknesses of the BLU 100a and the display apparatus 10 may be reduced. Alternative or additionally, since the plurality of reflectors 200 may be disposed at positions in which the amount of light may be relatively insignificant in the light source module 110, and allow light emitted from LEDs 190, which are adjacent thereto, to be reflected toward the front, a dark portion (e.g., mura) of the BLU 100a may be potentially removed and/or reduced.

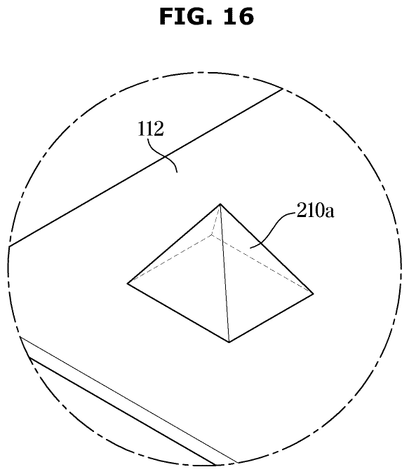

FIG. 16 is a view illustrating a protrusion of a reflector in a BLU 100, according to an embodiment.

Referring to FIG. 16, the BLU 100 may include a protrusion 210a having a quadrangular pyramid shape. That is, four side surfaces of the protrusion 210a having a quadrangular pyramid-shape may be arranged to respectively face light source 111 (not shown) corresponding thereto.

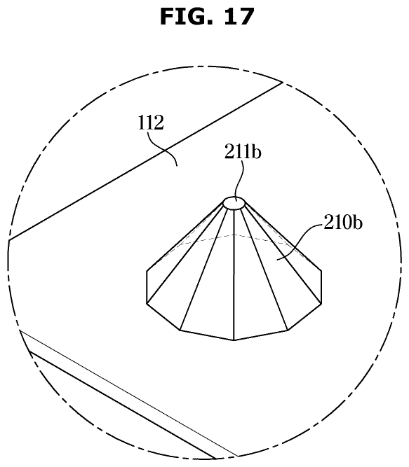

FIG. 17 is a view illustrating a protrusion of a reflector in a BLU 100, according to an embodiment.

Referring to FIG. 17, the BLU 100 according to an embodiment may include a protrusion 210b having a frustum of a poly-pyramid. The protrusion 210b having a frustum of a poly-pyramid may include an adhesive surface 211b to increase a contact area with the adhesive layer 130. According to one embodiment, the BLU 100 may include a frustum of a poly-pyramid with a bottom surface of a pentagon or more. Although not shown in the drawings, the 100 may include polygonal pyramid-shaped protrusions.

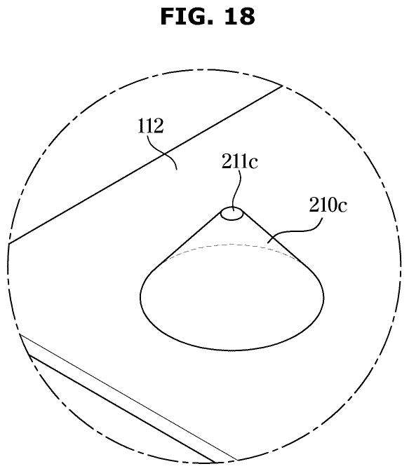

FIG. 18 is a view illustrating a protrusion of a reflector in a BLU 100, according to an embodiment.

Referring to FIG. 18, the BLU 100 may include a protrusion 210c having a truncated cone-shape. The protrusion 210c having a truncated cone-shape may include an adhesive surface 211c to increase a contact area with the adhesive layer 130. Although not shown in the drawing, the BLU 100 may include a cone-shaped protrusion.

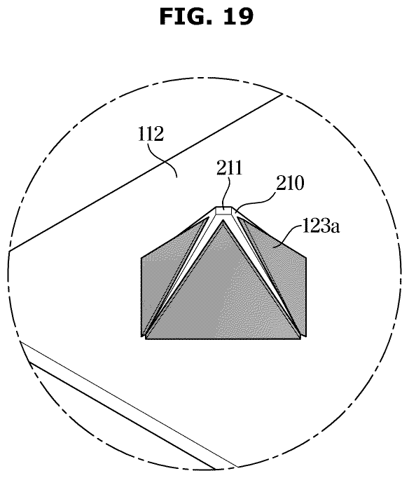

FIG. 19 is a view illustrating a reflector in a BLU 100, according to an embodiment.

Referring to FIG. 19, a BLU 100 may include a reflector 200 including a reflective surface coated with a phosphor.

The reflector 200 may include a protrusion 210 including an adhesive surface 211 and a protrusion cover 123a covering side surfaces of the protrusion 210. The protrusion cover 123a may present one region of the reflector sheet 120.

In an embodiment, a phosphor may be applied to the protrusion cover 123a, which may be one region of the reflector sheet 120. The protrusion cover 123a coated with the phosphor may cover the side surfaces of the protrusion 210, to form reflective surfaces of the reflector 200. The wavelength of light incident on the reflective surface coated with the phosphor may be converted. For example, a part of blue light incident on the reflective surface may be converted into red light and green light and reflected forward. In such an example, light reflected from the reflector 200 may be substantially similar to white light. As the phosphor may be coated on the reflective surface, the luminance and/or the luminance uniformity of the BLU 100 may be improved. Although the description above describes coating the reflector 200 using phosphor, it may be understood that other materials and/or combinations of materials may be used without departing from the scope of the present disclosure. That is, the reflector 200 may be covered with other combinations of materials that may convert the wavelength of the light incident on the reflective surface and/or may perform other modifications and/or enhancements on the incident light.

Although the present disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A display apparatus, comprising:
a liquid crystal panel; and
a backlight unit (BLU) configured to provide light to the liquid crystal panel,
wherein the BLU comprises:
a substrate;
a plurality of light-emitting diodes (LEDs) on the substrate and configured to emit the light;
a plurality of refractive covers, each refractive cover disposed on a corresponding LED of the plurality of LEDs; and
a plurality of reflectors on the substrate disposed between the plurality of LEDs and configured to reflect the light emitted from the plurality of LEDs.

2. The display apparatus of claim 1, wherein:
the plurality of LEDs are spaced apart from each other at a first interval along a first direction on the substrate; and
the plurality of LEDs are spaced apart from each other at the first interval along a second direction on the substrate,
wherein the second direction is perpendicular to the first direction.

3. The display apparatus of claim 2, wherein:
the plurality of reflectors are spaced apart from each other at a second interval along a third direction on the substrate,
the second interval is greater than the first interval, and
the third direction is diagonal to the first direction and to the second direction.

4. The display apparatus of claim 3, wherein:
each of the plurality of reflectors is provided in a shape of a frustum of a square pyramid, and
each side surface of the shape of the frustum of the square pyramid faces a corresponding adjacent LED of the plurality of LEDs.

5. The display apparatus of claim 3, wherein the plurality of reflectors are provided in a shape of at least one of a frustum of a cone, a frustum of a polygonal pyramid, a cone, and a polygonal pyramid.

6. The display apparatus of claim 1, wherein the plurality of reflectors comprises:
a plurality of protrusions protruding from the substrate toward the liquid crystal panel, each protrusion of the plurality of protrusions having at least one side surface; and
a plurality of protrusion covers respectively disposed on the at least one side surface of the plurality of protrusions to form at least one reflective surface on each protrusion of the plurality of protrusions.

7. The display apparatus of claim 6, wherein:
the BLU further comprises a reflector sheet disposed on the substrate,
the reflector sheet comprises:
the plurality of protrusion covers;
a plurality of through holes corresponding respectively to the plurality of LEDs; and
a plurality of cutouts formed by a portion of the reflector sheet incised such that at least one region of the reflector sheet forms the plurality of protrusion covers, and
each of the plurality of LEDs passes through the corresponding through hole of the plurality of through holes.

8. The display apparatus of claim 7, wherein the at least one region of the reflector sheet is coated with phosphor and configured to convert a wavelength of light incident on the at least one reflective surface.

9. The display apparatus of claim 1, wherein the BLU further comprises:
a composite sheet disposed between the substrate and the liquid crystal panel; and
an adhesive layer provided on a surface of the composite sheet and disposed between the composite sheet and the substrate, and configured to bond the composite sheet to the plurality of reflectors.

10. The display apparatus of claim 9, wherein the composite sheet comprises:
a reflector sheet configured to selectively reflect incident light;
a diffuser sheet configured to diffuse the incident light;
a light conversion sheet configured to convert a wavelength of the incident light; and
a prism sheet comprising a prism pattern.

11. The display apparatus of claim 9, wherein the plurality of reflectors support the composite sheet such that an air gap is formed between the composite sheet and the substrate.

12. The display apparatus of claim 1, wherein the BLU further comprises:
a diffuser plate disposed between the substrate and the liquid crystal panel and configured to diffuse incident light;
an optical sheet provided on a first surface of the diffuser plate and disposed between the diffuser plate and the liquid crystal panel, the optical sheet comprising at least one of a light conversion sheet, a prism sheet, and a reflective polarizing sheet; and
an adhesive layer provided on a second surface of the diffuser plate and configured to bond the diffuser plate to the plurality of reflectors.

13. The display apparatus of claim 1, wherein the plurality of LEDs are mounted on the substrate in a chip on board (COB) method.

14. The display apparatus of claim 1, wherein:
the plurality of refractive covers have been formed by a transparent material in a liquid state that has been dispensed at a plurality of points and cured, and
the transparent material in the liquid state has a refractive index higher than a refractive index of air.

15. A display apparatus, comprising:
a liquid crystal panel; and
a backlight unit (BLU) configured to provide light to the liquid crystal panel,
wherein the BLU comprises:
a substrate;
a plurality of light-emitting diodes (LEDs) on the substrate and configured to emit the light, the plurality of LEDs being spaced apart from each other at a first interval along a first direction on the substrate, the plurality of LEDs being spaced apart from each other at the first interval along a second direction on the substrate, and the second direction being perpendicular to the first direction;
a plurality of refractive covers, each refractive cover disposed on a corresponding LED of the plurality of LEDs, the plurality of reflectors being spaced apart from each other at a second interval along a third direction on the substrate, the second interval being greater than the first interval, and the third direction being diagonal to the first direction and to the second direction; and
a plurality of reflectors on the substrate disposed between the plurality of LEDs and configured to reflect the light emitted from the plurality of LEDs.

16. The display apparatus of claim 15, wherein:
each of the plurality of reflectors is provided in a shape of a frustum of a square pyramid, and
each side surface of the shape of the frustum of the square pyramid faces a corresponding adjacent LED of the plurality of LEDs.

17. The display apparatus of claim 15, wherein the plurality of reflectors comprises:
a plurality of protrusions protruding from the substrate toward the liquid crystal panel, each protrusion of the plurality of protrusions having at least one side surface; and
a plurality of protrusion covers respectively disposed on the at least one side surface of the plurality of protrusions to form at least one reflective surface on each protrusion of the plurality of protrusions.

18. The display apparatus of claim 15, wherein the BLU further comprises:
a composite sheet disposed between the substrate and the liquid crystal panel; and
an adhesive layer provided on a surface of the composite sheet and disposed between the composite sheet and the substrate, and configured to bond the composite sheet to the plurality of reflectors.

19. The display apparatus of claim 18, wherein the plurality of reflectors support the composite sheet such that an air gap is formed between the composite sheet and the substrate.

20. The display apparatus of claim 15, wherein the BLU further comprises:
a diffuser plate disposed between the substrate and the liquid crystal panel and configured to diffuse incident light;
an optical sheet provided on a first surface of the diffuser plate and disposed between the diffuser plate and the liquid crystal panel, the optical sheet comprising at least one of a light conversion sheet, a prism sheet, and a reflective polarizing sheet; and
an adhesive layer provided on a second surface of the diffuser plate and configured to bond the diffuser plate to the plurality of reflectors.
